(19) United States
(12) Patent Application Publication
(10) Pub. No.: US 2019/0245281 A1
(43) Pub. Date: Aug. 8, 2019

(54) TERMINAL

(71) Applicant: PHOENIX CONTACT GMBH & CO. KG, Blomberg (DE)

(72) Inventors: Markus SONDERER, Hoexter (DE); Andreas SCHRADER, Delbrueck (DE)

(21) Appl. No.: 16/319,361

(22) PCT Filed: Aug. 16, 2017
(86) PCT No.: PCT/EP2017/070792

§ 371 Date: Jan. 21, 2019

(30) Foreign Application Priority Data
Aug. 25, 2016 (LU) LU93183

(51) Int. Cl. H01R 4/48

(52) U.S. Cl. CPC H01R 4/4836

(57) ABSTRACT

A terminal for connecting an electrical conductor includes: a housing; a current bar; a clamping spring, which has a retaining leg and a clamping leg, the conductor being clampable against the current bar by the clamping leg; and a pivotably mounted actuating element for actuating the clamping spring. The actuating element has an axis body about which the actuating element is pivotable. A holding device in which the axis body is rotatably mounted is arranged on the retaining leg.

### CROSS-REFERENCE TO PRIOR APPLICATIONS

This application is a U.S. National Phase application under 35 U.S.C. § 371 of International Application No. PCT/EP2017/070792, filed on Aug. 16, 2017, and claims benefit to Luxembourg Patent Application No. LU93183, filed on Aug. 25, 2016. The International Application was published in German on Mar. 1, 2018 as WO 2018/036886 under PCT Article 21(2).

### FIELD

The invention relates to a terminal for connecting an electrical conductor, which has a housing, a current bar, a clamping spring, which has a retaining leg and a clamping leg, wherein the conductor can be clamped against the current bar by means of the clamping leg, and a pivotably mounted actuating element for actuating the clamping spring.

### BACKGROUND

DE 10 2011 056 410 A1 discloses a corresponding lever-operated terminal which has a clamping spring, designed as a leg spring, for clamping an electrical conductor, inserted into the terminal, against a current bar. The actuating element for actuating the clamping spring has an axis of rotation which is arranged transversely to the conductor insertion direction in an associated conductor insertion opening or to the extension of the conductor insertion opening extending further in the conductor insertion direction to the clamping point. The placement of the axis of rotation in the region of the clamping point or in alignment with the insertion opening in front of it is intended to ensure that the clamping spring is actuated relatively close to the axis of rotation of the actuating element, as a result of which the lever forces acting on the housing of the terminal are to be reduced.

### SUMMARY

In an embodiment, the present invention provides a terminal for connecting an electrical conductor, comprising: a housing; a current bar; a clamping spring, which has a retaining leg and a clamping leg, the conductor being clampable against the current bar by the clamping leg; and a pivotably mounted actuating element configured to actuate the clamping spring, wherein the actuating element has an axis body about which the actuating element is pivotable, and wherein a holding device in which the axis body is rotatably mounted is arranged on the retaining leg.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a schematic cross-sectional view of a terminal according to the invention, with the clamping spring in the closed position,

FIG. 2 a schematic perspectival view of the actuating element, the clamping spring, and the current bar of the terminal shown in FIG. 1, with the clamping spring in the closed position,

FIG. 3 a schematic sectional view of the terminal shown in FIG. 1, with the clamping spring in the open position, and

FIG. 4 a schematic perspectival view of the clamping spring of the terminal shown in FIG. 1.

### DETAILED DESCRIPTION

In an embodiment, the present invention provides a terminal by means of which the forces acting on the housing when a conductor is clamped can be further reduced.

The terminal according to the invention is characterized in that the actuating element has an axis body about which the actuating element can be pivoted, wherein a holding device in which the axis body is rotatably mounted is arranged on the retaining leg of the clamping spring.

According to the invention, it is now provided that the actuating element be mounted directly on the retaining leg of the clamping spring, which, in contrast to the clamping leg of the clamping spring, is fixed in position in the terminal—in particular, the housing of the terminal. The retaining leg preferably lies flat against the housing—in particular, flat against an interior wall adjacent to a clean interior of the housing surface. The actuating element is mounted on the retaining leg of the clamping spring with its axis body, so that the axis of rotation of the actuating element that runs through the axis body is positioned in the region of the clamping spring. For mounting the actuating element or the axis body of the actuating element on the clamping spring, a holding device in which the axis body is rotatably positioned is arranged on the clamping spring. The holding device is preferably integrally formed directly on the retaining leg of the clamping spring. The holding device is preferably formed as one piece together with the retaining leg, so that the holding device is bent out of the metal strip of the clamping spring. By virtue of the mounting of the actuating element directly on the retaining leg of the clamping spring, the forces acting on the housing when a conductor is clamped can be substantially reduced in that the forces for actuating the clamping spring, which act on the clamping spring from the actuating element, can be retained within the clamping spring.

In order to be able to achieve a secure, rotatable mounting of the axis body of the actuating element in the holding device, it is preferably provided that the holding device be U-shaped and at least partially enclose the axis body. The shape of the holding device is preferably adapted to the outer contour of the axis body so that an optimal guidance of the axis body within the holding device can be achieved during a pivoting movement of the actuating element.

The clamping spring is preferably designed in such a way, that the retaining leg has an opening through which a free end of the current bar is passed and through which the conductor to be connected can be passed. The opening is preferably designed as a window-like opening and serves both for passing the current bar through and for passing the conductor to be connected through. By virtue of both the current bar and the conductor to be connected being guided through the opening of the current bar, the forces occurring when the conductor is clamped against the current bar can also be transmitted to the retaining leg and thus to the clamping spring, so that the forces can be absorbed by the clamping spring, and thus a transmission of the clamping forces to the housing of the terminal can largely be avoided. This allows the forces acting when a conductor is clamped to the housing to be further reduced.

The holding device is preferably arranged above the opening and above the current bar, guided through the opening, on the retaining leg of the clamping spring. This positioning of the holding device and the current bar and the opening relative to one another makes it possible to achieve a space-saving arrangement of the individual parts within the terminal, whereby the overall size of the terminal can be reduced.

The reduction in the overall size of the terminal can further be achieved by the clamping leg being integrally formed on a first free end of the retaining leg and by the holding device being arranged on a second free end of the retaining leg opposite the first free end. The opening in the retaining leg is formed between the two free ends of the retaining leg. The arrangement of the clamping leg on the retaining leg and the arrangement of the holding device on the retaining leg is preferably provided on one and the same longitudinal side surface of the retaining leg, and in fact on the longitudinal side surface, which points in the direction of the interior of the housing and, hence, the interior of the terminal, in which the connection or clamping of the conductor against the current bar takes place.

The clamping leg of the clamping spring is preferably shaped in such a way that it has a contact region by means of which the clamping leg bears against a longitudinal side surface of the retaining leg, so that, when the clamping leg moves into an open position and into a closed position of the clamping spring, it can be displaced along the longitudinal side surface of the retaining leg. When the clamping spring is actuated, a part of the clamping leg can thus slide along the retaining leg, so that a defined guidance of the clamping leg can be formed by means of the retaining leg.

It is preferably provided that the clamping leg not be of rectilinear design, but, rather, that the clamping leg have an S shape. The clamping force to be applied via the clamping leg can be increased by the S shape of the clamping leg without increasing the overall dimensions—in particular, the width—of the clamping spring. In addition, the spring action of the clamping leg can be improved.

To form the S shape, the clamping leg can have a first deflection section connected to the retaining leg, a second deflection section connected to the first deflection section via a bending joint, and a clamping section connected to the second deflection section via the contact region. The two deflection sections and also the clamping portion preferably have a rectilinear design, whereas the bending joint and the contact region are preferably bent. The two deflection sections preferably have the same length, whereas the clamping section preferably has a substantially shorter length. For example, the clamping section has a length which is approximately one third the length of a deflection section. The two deflection sections together with the retaining leg preferably form a delta shape. The spring action of the clamping leg is preferably achieved via the two deflection sections, wherein the deflection sections are arranged at a distance from the conductor to be connected. The conductor is connected or clamped via the clamping section of the clamping leg.

The actuating element is preferably designed in such a way that it has a first actuating web and a second actuating web arranged parallel thereto, by means of which the clamping spring is actuated, wherein the axis body is preferably arranged between the first actuating web and the second actuating web. The actuating webs are elongated and extend from the axis body to the clamping leg of the clamping spring, wherein the actuating webs press on the clamping leg by a pivoting movement of the actuating element and thus exert a force on the clamping leg in order to actuate the clamping spring. By virtue of two actuating webs arranged parallel to one another pressing simultaneously on the clamping leg during actuation, a uniform force distribution over the width of the clamping leg can be achieved, wherein tilting of the actuating element and/or of the clamping spring during actuation of the clamping spring can be avoided. By virtue of the axis body being arranged between the two actuating webs, the actuating webs can also form a locking of the axis body in the holding device, since they can prevent the axis body from slipping sideways out of the holding device.

When the clamping spring is actuated, the actuating webs preferably do not press directly on the clamping section of the clamping leg and thus not on the part of the clamping leg which is in direct contact with the clamped conductor; rather, for actuating the clamping spring, the actuating webs are, preferably, operatively connected to the second deflection section of the clamping spring, which has no direct contact with the conductor to be connected. This makes it possible to substantially reduce the force to be applied by the operator to the actuating element for actuating the clamping spring due to the longer lever arm between the actuating element or the axis body of the actuating element and the point of engagement of the actuating element on the clamping leg of the clamping spring, whereby the operating comfort for the operator of the terminal can be increased.

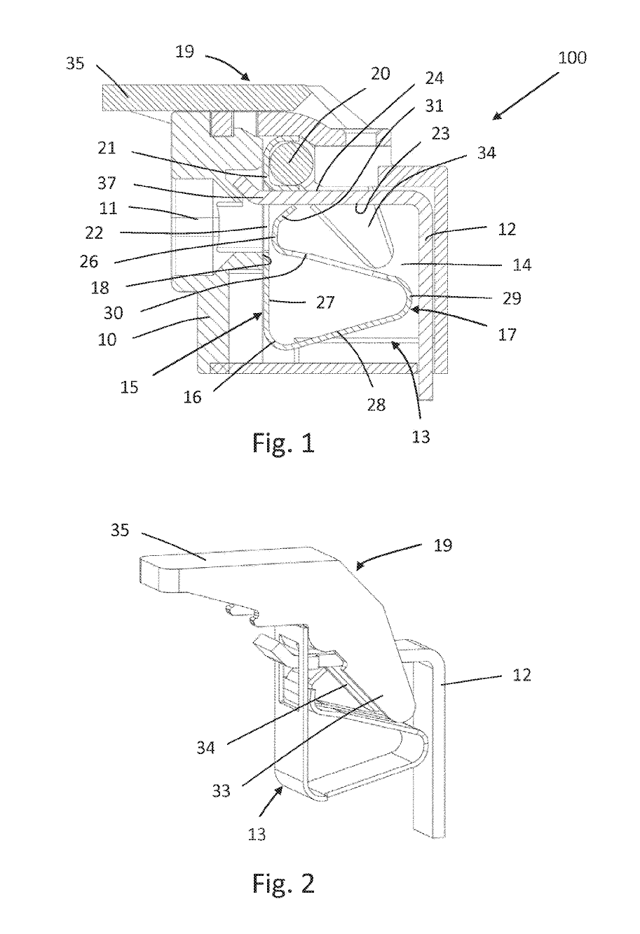

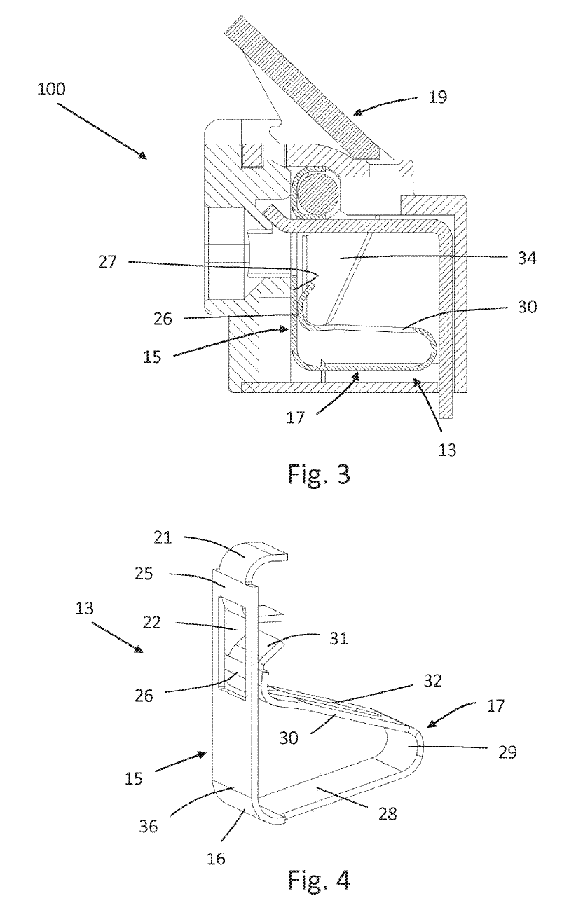

FIGS. 1 and 3 show a sectional view of a terminal 100 for the connection of an electrical conductor, wherein the terminal 100 is shown, in FIG. 1, in a closed position and, in FIG. 3, in an open position.

The terminal 100 has a housing 10 made of an insulating material, wherein the housing 10 has a conductor insertion opening 11 for inserting the conductor to be connected into the terminal 100.

Arranged In the housing 10 is a current bar 12, against which the conductor to be connected can be clamped in an electrically contacting manner.

For clamping the conductor against the current bar 12, the terminal 100 has a clamping spring 13 which is arranged in an inner space 14 of the housing 10. The clamping spring 13 has a retaining leg 15 and a clamping leg 17 connected to the retaining leg 15 via a bent section 16. The retaining leg 15, at least in sections, rests flat against an inner wall 18 of the housing 10 which delimits the interior 14 of the housing 10. The retaining leg 15 is thus arranged in the housing 10 in a fixed position. In contrast to the retaining leg 15, the clamping leg 17 extends into the interior 14 of the housing 10, wherein the clamping leg 17 is resiliently movable in the interior 14 of the housing 10. The conductor is clamped against the current bar 12 by means of the clamping leg 17.

For actuating the clamping spring 13 in order to transfer it into an open position and/or a closed position, the terminal 100 has a pivotably mounted actuating element 19. The actuating element 19 has an axis body 20 in the form of a shaft, wherein the axis of rotation of the actuating element 19 passes through the axis body 20, so that the actuating element 19 can be pivoted about the axis body 20. The axis body 20 is mounted in a holding device 21 which is arranged on the retaining leg 15 of the clamping spring 13. The axis body 20 is thus mounted on the clamping spring 13, and not directly on the housing 10. As a result, the forces acting on the clamping spring 13 when a conductor is clamped by the actuating element 19 can be kept within the clamping spring 13 so that the forces acting on the housing 10 can be substantially reduced.

FIG. 4 shows just the clamping spring 13 and the holding device 21 arranged thereon, without the other parts of the terminal 100. In the embodiment shown here, the holding device 21 is formed integrally with the clamping spring 13 by the holding device 21 being bent out of the strip material of the clamping spring 13. The holding device 21 has a slightly smaller width than the retaining leg 15. The holding device 21 is bent in a U shape or a C shape, so that the holding device 21 at least partially surrounds the axis body 20, which is circular in cross-section. The contour of the holding device 21 is thus adapted to the contour of the axis body 20.

Below the connection of the holding device 21 to the retaining leg 15, a window-like opening 22 is formed in the retaining leg 15 through which a free end 37 of the current bar 12 is passed, as can be seen in FIGS. 1-3, and through which the conductor to be connected can be passed. The conductor introduced into the interior 14 of the housing 10 through the opening 22 is clamped by means of the clamping leg 17 of the clamping spring 13 against a first side surface 23, directed toward the inner space 14 of the housing 10, of the current bar 12. With a second side face 24, opposite the first side face 23, that points away from the interior 14 of the housing 10, the current bar 12 bears against the holding device 21—in particular, on an outer face of the holding device 21. The holding device 21 and the clamping leg 17 of the clamping spring 13 are thus separated from one another by the current bar 12. The opening 21 in the retaining leg 15 is arranged in alignment with the conductor insertion opening 11 in the housing 10.

In the embodiment shown here, the holding device 21 and the clamping leg 18 are arranged at spaced-apart ends 36, 25 of the retaining legs 15, so that a maximum possible distance is formed between the holding device 21 and the clamping leg 18. The clamping leg 17 is mounted on a first free end 36 of the retaining leg 15, and the holding device is formed on a second free end 25, opposite the first free end 36, of the retaining leg 15.

As can be seen in FIGS. 2 and 4, the clamping leg 17 has a smaller width than the retaining leg 15.

The retaining leg 15 of the clamping spring 13 is of rectilinear design.

In contrast, the clamping leg 17 of the clamping spring 13 is not rectilinear; rather, the clamping leg 17 is divided into several sections, each of which is arranged at an angle with respect to the other of between 10° and 80°. The clamping leg 17 thus has an S shape.

The clamping leg 17 is, inter alia, formed in such a way that it has a contact region 26 by means of which the clamping leg 17 rests against a longitudinal side surface 27, directed towards the interior 14 of the housing 10, of the retaining leg 15, so that, upon movement of the clamping leg 17 into an open position and into a closed position of the clamping spring 13, the clamping leg 17 is displaced along the longitudinal side surface 27. This contact region 26 has a curved shape.

To form the S shape, the clamping leg 17 also has a first deflection section 28 connected to the retaining leg 15, a second deflection section 30 connected to the first deflection section 28 via a bending joint 29, and a clamping section 31 connected to the second deflection section 30 via the contact region 26. The spring action of the clamping leg 17 is achieved via the two deflection sections 28, 30, which are movable relative to one another via the bending joint 29. The two deflection sections 28, 30 have approximately the same length. Together with a part of the retaining section 15, the deflection sections 28, 30 form a delta shape. In the second deflection section 30, a longitudinal slot 32 is formed which extends over the entire length of the deflection section 30. The spring action of the clamping leg 17 can be increased by provision of the longitudinal slot 32 in the deflection section 30. The clamping of the conductor is effected via direct contact of the clamping section 31 of the clamping leg 17 with the conductor. The clamping section 31 has a substantially smaller length than the deflection sections 28, 30. The length of the clamping section 31 is less than one third the length of one of the deflection sections 28, 30. The width of the clamping leg 17 is constant over the two deflection sections 28, 30, the bending joint 29, and the contact region 26, whereas the clamping section 31 has a smaller width and is thus narrower than the two deflection sections 28, 30, the bending joint 29, and the contact region 26.

For actuating the clamping spring 13, the actuating element 19 has a first actuating web 33 and a second actuating web 34 arranged parallel thereto, as can be seen in particular in FIG. 2, wherein the axis body 20 is arranged between the first actuating web 33 and the second actuating web 34. Starting from the axis body 20, the two actuating webs 33, 34 project into the interior 14 of the housing 10. The two actuating webs 33, 34 are each guided laterally past the current bar 12 so that the current bar 12 is arranged between the two actuating webs 33, 34. The actuating webs 33, 34 thus surround the current bar 12.

The actuating webs 33, 34 are of such a length that, for actuating the clamping spring 13, they are operatively connected to the second deflection section 30 of the clamping spring 13 and are not operatively connected to the clamping section 31. When the clamping spring 13 or the terminal 100 moves into the open position and into the closed position, the actuating webs 33, 34 are moved or displaced along the surface of the second deflection section 30, as can be seen in FIGS. 1 and 3.

The actuating element 19 also has a handle 35 via which an operator of the terminal 100 can grip and pivot the actuating element 19. The handle of the actuating element 19 projects out from the housing 10. The handle 35, the axis body 20, and the actuating webs 33, 34 are integrally connected to each other.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference numbers

| | |
|---|---|
| Terminal | 100 |
| Housing | 10 |
| Conductor insertion opening | 11 |
| Current bar | 12 |
| Clamping spring | 13 |
| Interior | 14 |
| Retaining leg | 15 |
| Bent section | 16 |
| Clamping leg | 17 |
| Inner wall | 18 |
| Actuating element | 19 |
| Axis body | 20 |
| Holding device | 21 |
| Opening | 22 |
| First side surface | 23 |
| Second side surface | 24 |
| Second free end of the retaining leg | 25 |
| Contact region | 26 |
| Longitudinal side surface | 27 |
| First deflection section | 28 |
| Bending joint | 29 |
| Second deflection section | 30 |
| Clamping section | 31 |
| Longitudinal slot | 32 |
| First actuating web | 33 |
| Second actuating web | 34 |
| Handle | 35 |
| First free end of the retaining leg | 36 |
| Free end of the current bar | 37 |

1. A terminal for connecting an electrical conductor, comprising:
a housing;
a current bar,
a clamping spring, which has a retaining leg and a clamping leg, the conductor being clampable against the current bar by the clamping leg; and
a pivotably mounted actuating element configured to actuate the clamping spring,
wherein the actuating element has an axis body about which the actuating element is pivotable, and
wherein a holding device in which the axis body is rotatably mounted is arranged on the retaining leg.

2. The terminal according to claim 1, wherein the holding device is U-shaped and at least partially surrounds the axis body.

3. The terminal according to claim 1, wherein the retaining leg has an opening through which a free end of the current bar is passed and through which the conductor to be connected is passable.

4. The terminal according to claim 3, wherein the holding device is arranged above the opening and above the current bar which is guided through the opening on the retaining leg.

5. The terminal according to claim 1, wherein the clamping leg is integrally formed on a first free end of the retaining leg, and
wherein the holding device is arranged on a second free end of the retaining leg opposite the first free end.

6. The terminal according to claim 1, wherein the clamping leg has a contact region via which the clamping leg bears against a longitudinal side surface of the retaining leg, so that, when the clamping leg moves into an open position and into a closed position of the clamping spring, the clamping leg is displaceable along the longitudinal side surface of the retaining leg.

7. The terminal according to claim 1, wherein the clamping leg has an S shape.

8. The terminal according to claim 7, wherein, to form the S shape, the clamping leg has a first deflection section connected to the retaining leg, a second deflection section connected to the first deflection section via a bending joint, and a clamping section connected to the second deflection section via the contact region.

9. The terminal according to claim 8, wherein the actuating element has a first actuating web and a second actuating web arranged parallel thereto, by which the clamping spring is actuable, and
wherein the axis body is arranged between the first actuating web and the second actuating web.

10. The terminal according to claim 9, wherein the first and second actuating webs clamping spring are operatively connected to the second deflection section of the clamping spring.
